(19) United States
(12) Patent Application Publication
(10) Pub. No.: US 2011/0023976 A1
(43) Pub. Date: Feb. 3, 2011

(54) FLUIDIC DEVICE WITH PLANAR COUPLING MEMBER

(75) Inventors: Martin Baeuerle, Buehlertal (DE); Jochen Mueller, Waldbronn (DE); Konstantin Choikhet, Karlsruhe (DE); Klaus Witt, Keltern (DE)

Correspondence Address: Agilent Technologies, Inc. in care of:;CPA Global, P. O. Box 52050, Minneapolis, MN, 55402, US

(73) Assignee: AGILENT TECHNOLOGIES, INC., Loveland, CO (US)

(21) Appl. No.: 12/935,911

(22) PCT Filed: Apr. 3, 2008
(86) PCT No.: PCT/EP08/53985

§ 371 Date: Oct. 1, 2010

(51) Int. Cl. F15C 5/00; B23K 31/02

(52) U.S. Cl. 137/15.18; 228/172; 137/625.46

(57) ABSTRACT

A fluidic device for providing fluidic connections is described. The fluidic device comprises a fluid conduit and a planar coupling member with a fluid port, the fluid port being fluidically connected with the fluid conduit. A contour of the planar coupling member is in a predefined relationship with the fluid port's position.

### BACKGROUND ART

The present invention relates to a fluidic device for providing fluidic connections, to a fluidic system, and to an interconnection strip for providing fluidic connections. The present invention further relates to a method for manufacturing a fluidic device, and to a method for fluidically connecting a first fluidic device and a second fluidic device.

WO 00/78454 A1, DE 19928412 A1, and U.S. Pat. No. 6,814,846 by the same applicant Agilent Technologies show different microfluidic chips and applications. Other microfluidic devices and applications are disclosed e.g. in WO 98/49548, U.S. Pat. No. 6,280,589, or WO 96/04547.

EP 1715348 relates to a handling unit adapted for handling a microfluidic device. The handling unit comprises a first clamping element and a second clamping element, and an actuation mechanism adapted for driving at least one of the clamping elements.

The article “Fluidic interconnects for modular assembly of chemical microsystems” by C. Gonzalez et al., Sensors and Actuators B 49 (1998), pages 40-45 discloses an assembly technology which enables the modular interconnection, assembly and packaging of individual microfabricated components and/or modules.

WO 06/07878 A1 relates to a microfluidic arrangement for the optical detection of fluids. The arrangement comprises a microfluidic device having at least one first channel with an opening which is in fluid communication with an optical detection unit.

U.S. Pat. No. 6,538,207 B1 relates to fluidic, electrical, electronic, and optical flex circuits, also known as flexible circuits, and connections thereto.

U.S. Pat. No. 6,702,256 B2 relates to a flow-switching microdevice and to fluid flow control in microdevices. More specifically, the application relates to microdevices that employ a high pressure capable valve structure.

US 2005/0048669 A1 relates to interfaces between microfluidic devices and related instruments or systems, and in particular to a gasketless microfluidic device interface.

WO 05/84808 A1 discloses a frame for a microfluidic chip, the frame being adapted for receiving the microfluidic chip, or for protecting the microfluidic chip, or for positioning the microfluidic chip relative to the frame. Thus, sensitive parts of the microfluidic chip can be protected during handling, storage, and transport.

### DISCLOSURE

It is an object of the invention to provide an improved fluidic coupling technique for fluidically connecting fluidic devices. The object is solved by the independent claim(s). Further embodiments are shown by the dependent claim(s).

A fluidic device according to embodiments of the present invention is adapted for providing fluidic connections and comprises a fluid conduit and a planar coupling member with a fluid port. The fluid port is fluidically connected with the fluid conduit. A contour of the planar coupling member is in a predefined relationship with the fluid port's position.

The contour of the planar coupling member may e.g. be clamped or gripped by some sort of clamping device. Because of the predefined relationship between the fluid port's position and the contour of the planar coupling member, the fluid port is brought to a well-defined position when the planar coupling member is clamped, gripped or fastened. Hence, the position of the fluid port is known. The well-known position of the fluid port may e.g. be used for establishing a fluidic connection with any other fluidic device. Thus, the fluidic coupling technique according to embodiments of the present invention provides a simple standard for establishing fluidic connections between fluidic devices.

In particular, the fluidic coupling technique according to embodiments of the present invention may be used instead of conventional capillaries, whereby the shortcomings of capillary fittings are avoided. For example, by employing planar coupling members for establishing fluidic connections, dead volume of the fittings is reduced, and reliability of the fluidic connection is improved.

According to a preferred embodiment, the planar coupling member protrudes laterally from the fluidic device. Further preferably, the planar coupling member is an accessory member that protrudes laterally from the fluidic device. Via the planar coupling member's fluid port, fluidic connections with other fluidic devices can be set up.

According to a preferred embodiment, the planar coupling member is realized as a planar multilayer structure. Preferably, the planar coupling member is realized as a stack of two or more bonded sheets. For example, for manufacturing the planar coupling member, microstructured sheets may be stacked on top of one another and bonded. Further preferably, the planar coupling member is realized as a stack of two or more bonded metal sheets. A planar coupling member realized in this way is robust and durable and can withstand high fluid pressures.

Preferably, one or more of the sheets are machined in a way that the fluid conduit is formed in the stack. According to a preferred embodiment, an abrasive process, preferably electrochemical milling or chemical milling, is used for processing the metal sheets. Further preferably, the fluid port is realized as a via hole in an uppermost sheet, or in a lowermost sheet, or in both the uppermost and the lowermost sheet of the planar coupling member.

According to a preferred embodiment, the planar coupling member is realized as a stack of two or more bonded metal sheets, the metal sheets being coated with plastic material or with a hot-melt adhesive before being bonded.

According to a preferred embodiment, the planar coupling member is realized as a stack of two or more bonded metal sheets, the metal sheets being bonded by a joining process, preferably by diffusion welding. In diffusion welding, the stack of metal sheets is placed in a vacuum and exposed to heat for a certain period of time, whereby the metal sheets are pressed against one another. As a result, strong bonds are formed between the metal sheets. Preferably, the metal sheets are electroplated before being bonded by diffusion welding.

In a preferred embodiment, the fluidic device as a whole is realized as a stack of two or more bonded sheets. Preferably, the fluidic device is realized as a stack of two or more bonded metal sheets. In this embodiment, the fluidic device as a whole is realized as a planar structure.

According to a preferred embodiment, the planar coupling member is realized as a stack of two or more metal sheets, wherein an abrasive process, preferably electrochemical milling or chemical milling, is used for processing at least one of: the fluid conduit of the fluidic device, the outer contour of the sheets.

According to a preferred embodiment, the contour of the planar coupling member is an outer contour. Preferably, the contour of the planar coupling member is provided by the planar coupling member's boundary. By gripping or clamping the outer contour of the planar coupling member, the planar coupling member may e.g. be aligned with another planar coupling member of another fluidic device. According to an alternative embodiment, the contour of the planar coupling member is an inner contour of a cut-out of the planar coupling member. According to a further preferred embodiment, the contour of the planar coupling member is one of: a circular contour, a polygonal contour. Due to the specific shape of the planar coupling member's contour, an alignment of the planar coupling ember is enforced when the planar coupling member is gripped or clamped. Dependent on the particular contour, a specific orientation of the planar coupling member may be enforced as well. The planar coupling member's contour may e.g. enforce an unambiguous alignment with a corresponding contour of another planar coupling member.

According to a preferred embodiment, the fluidic device is an interconnection strip comprising a first planar coupling member at the interconnection strip's first end and a second planar coupling member at the interconnection strip's second end. Preferably, the first planar coupling member comprises a first fluid port, the second planar coupling member comprises a second fluid port, and the interconnection strip comprises a fluid conduit adapted for fluidically connecting the first fluid port and the second fluid port. The planar interconnection strip is capable of establishing fluidic connections between different fluidic devices and provides the functionality of a conventional capillary. The fittings of conventional capillaries introduce dead volume to a flow path. In contrast, when clamping together planar coupling members according to embodiments of the present invention, no extra dead volume is introduced. Another advantage is that when using a planar connection technique according to embodiments of the present invention, fluidic connections may be detached and re-established as often as desired.

In a preferred embodiment, the planar coupling member comprises a contact surface, the fluid port being located within the contact surface. For example, the contact surface of a first planar coupling member may be pressed against the contact surface of another planar coupling member, whereby a fluidic connection is established. Due to the close contact between the two contact surfaces, a fluid-tight seal is accomplished. Preferably, the fluid port is located within the contact surface, and the contact surface's area is several times as large as the fluid port's cross section.

According to a preferred embodiment, the fluidic device comprises a plurality of fluid conduits, and the planar coupling member comprises a plurality of fluid ports, the fluid ports being fluidically coupled with corresponding fluid conduits. Hence, a plurality of fluidic connections can be established in parallel.

According to a further preferred embodiment, the planar coupling member is adapted for being clamped together with another planar coupling member of another fluidic device, wherein a fluidic connection is established between the fluid port of the planar coupling member and a corresponding fluid port of said another planar coupling member. Due to the specific relationship between the contour and the position of the fluid port, the fluid ports of the two planar coupling members are both located at a predefined position relative to the contours of the planar coupling members. When the respective contours of the two planar coupling members are aligned, the position of the first planar coupling member's fluid port matches with the position of the second planar coupling member's fluid port. The two fluid ports are positioned directly above one another. By pressing the planar coupling member against the other planar coupling member with a certain contact pressing force, a fluid-tight fluidic connection is accomplished.

Preferably, the fluidic device comprises one of: a switching valve, a reaction chamber, a pumping unit, a heat exchanger, a mixing device.

A fluidic system according to an embodiment of the present invention comprises a first fluidic device as described above, with the first fluidic device comprising a first planar coupling member. The fluidic system further comprises a clamping device comprising a fitting adapted to the contour of the first planar coupling member, the clamping device being adapted for clamping the first planar coupling member and for bringing the fluid port of the first planar coupling member to a predefined position.

According to a preferred embodiment, the fluidic system further comprises a second fluidic device as described above, the second fluidic device comprising a second planar coupling member.

According to a preferred embodiment, the clamping device is adapted for clamping together the first planar coupling member of the first fluidic device and the second planar coupling member of the second fluidic device, thereby establishing a fluidic connection between the fluid port of the first planar coupling member and a corresponding fluid port of the second planar coupling member.

According to a further preferred embodiment, the first planar coupling member comprises a plurality of fluid ports, the second planar coupling member comprises a plurality of fluid ports, and a plurality of fluidic connections are established between the fluid ports of the first planar coupling member and corresponding fluid ports of the second planar coupling member. By clamping together the first planar coupling member and the second planar coupling member, a plurality of well-defined flow paths may be set up in parallel between the first and the second planar coupling member.

In a preferred embodiment, the first planar coupling member's contour matches with the second planar coupling member's contour.

According to a preferred embodiment, the first planar coupling member comprises a plurality of fluid ports, the second planar coupling member comprises a plurality of fluid ports, each of the fluid ports' positions being in a predefined relationship with a contour of the respective planar coupling member. By aligning the first planar coupling member with the second planar coupling member, the respective positions of the fluid ports of the first and the second planar coupling member match as well, which is due to the predefined relationship between the contours and the respective positions of the fluid ports.

Preferably, the clamping device is adapted for aligning the first planar coupling member of the first fluidic device with the second planar coupling member of the second fluidic device, to provide for a fluidic connection between the fluid port of the first planar coupling member and a corresponding fluid port of the second planar coupling member.

According to a preferred embodiment, the clamping device is adapted for pressing a contact surface of the first planar coupling member against a corresponding contact surface of the second planar coupling member, thereby establishing a fluidic connection between the fluid port of the first planar coupling member and a corresponding fluid port of the second planar coupling member. By applying a clamping force to the planar coupling members, a fluid-tight fluidic coupling between corresponding fluid ports of the first and the second planar coupling member is accomplished.

According to a further preferred embodiment, a small plate, preferably a gold plate, is placed between the contact surface of the first planar coupling member and the corresponding contact surface of the second planar coupling member.

In a preferred embodiment, the contact surfaces serve as sealing surfaces.

According to a preferred embodiment, the clamping device is adapted for providing a detachable connection between the first planar coupling member and the second planar coupling member. For establishing a fluidic connection, the first and the second planar coupling member are aligned and pressed against one another. For detaching the fluidic connection, the grip of the clamping device is loosened, and the planar coupling members may be removed. Hence, by clamping and unclamping the planar coupling members, fluidic connections between fluidic devices may be set up and detached as desired. In contrast to conventional capillaries, setting up and detaching fluidic connections between planar coupling members does not impair the planar coupling members.

According to a preferred embodiment, a clamping force of the clamping device is sufficiently strong to provide for a fluid-tight fluidic connection between the fluid port of the first planar coupling member and the corresponding fluid port of the second planar coupling member.

Preferably, a clamping force of the clamping device is sufficiently strong to provide for a fluid-tight fluidic connection at fluid pressures of up to 1200 bar.

In a preferred embodiment, for pressing the first planar coupling member against the second planar coupling member, the clamping device comprises one or more of: a screw, a headless screw, a grub screw, a wedge, a clamp lever, a bent lever, a bell-crank lever, a hydraulic cylinder. For example, the first and the second planar coupling member may be clamped together by tightening a screw, or by actuating a clamp lever, etc. In case a hydraulic cylinder is employed for clamping the first and the second planar coupling member, clamping of the planar coupling members may be automated.

According to a preferred embodiment, the clamping device comprises a grub screw adapted for pressing a contact surface of the first planar coupling member against a contact surface of the second planar coupling member when the grub screw is tightened.

According to a preferred embodiment, the clamping device is adapted for clamping the first planar coupling member at different positions relative to the second planar coupling member, wherein in each of the different positions, different fluidic connections are set up between fluid ports of the first planar coupling member and fluid ports of the second planar coupling member. Thus, a switching functionality for switching between different flow paths can be implemented.

In a preferred embodiment, the first fluidic device comprises two or more different channels having different cross-sections, each of the channels being fluidically connected to a corresponding fluid port of the first planar coupling member, wherein one of the two or more different channels may be selected by setting the first planar coupling member to one of a set of different positions relative to the second planar coupling member. In dependence on a respective application, a channel having a suitable cross section may be selected.

According to a preferred embodiment, the clamping device is adapted for clamping together three or more planar coupling members of three or more different fluidic devices, thereby establishing fluidic connections between the three or more planar coupling members.

According to a preferred embodiment, at least one of the first planar coupling member and the second planar coupling member comprises interlocking features that enforce a well-defined alignment of the first planar coupling member relative to the second planar coupling member. In case the first and the second planar coupling member are arranged at a predefined position and orientation relative to one another, interlocking features of the first planar coupling member engage with corresponding interlocking features of the second planar coupling member. Thus, a predefined positioning and alignment of the planar coupling members is enforced. Preferably, the interlocking features comprise one or more of: a protrusion, a nose, a catching recess, a cut-out. Further preferably, a protrusion or a nose of one of the planar coupling members is adapted for engaging with a corresponding catching recess or a cut-out of the respective other planar coupling member, to enforce a well-defined alignment of the first planar coupling member relative to the second planar coupling member.

According to a preferred embodiment, the clamping device comprises a fitting for a tubing or for a capillary, the clamping device being adapted for clamping the first planar coupling member of the first fluidic device in a way that a fluidic connection between the fluid port of the first planar coupling member and an inlet of the tubing or the capillary is established. A clamping device according to this embodiment is capable of establishing a fluidic connection between the planar fluidic coupling technique according to embodiments of the present invention and conventional capillaries and tubings of the prior art.

According to a preferred embodiment, the clamping device comprises a stator element of a switching valve, the stator element comprising a set of stator ports, the clamping device being adapted for pressing the first planar coupling member against the stator element, thereby establishing fluidic connections between fluid ports of the first planar coupling member and corresponding stator ports of the stator element. Preferably, the fluidic system further comprises a rotor element pivotably mounted on the stator element.

According to a preferred embodiment, the clamping device comprises a fitting for a detection cell, the clamping device being adapted for clamping the first planar coupling member of the first fluidic device in a way that a fluidic connection between the fluid port of the first planar coupling member and an inlet of the detection cell is established.

According to a preferred embodiment, at the first planar coupling member, the fluid conduit of the first fluidic device branches out into a plurality of ramified fluid conduits, each fluid conduit being adapted for supplying fluid to a detection cell. Thus, fluid may be supplied to the detection cell in a way that any kind of turbulence is avoided, and disturbances of the measurement result are prevented.

According to a further preferred embodiment, the clamping device comprises a fitting for a separation column, the clamping device being adapted for clamping the first planar coupling member of the first fluidic device in a way that a fluidic connection between the fluid port of the first planar coupling member and an inlet of the separation column is established.

In a preferred embodiment, the first planar coupling member is adapted for supplying fluid to a separation column. Preferably, the first planar coupling member comprises a plurality of fluid ports adapted for supplying fluid to an inlet of a separation column, the plurality of fluid ports being adapted to provide for a homogeneous supply of fluid to the separation column.

An interconnection strip according to embodiments of the invention is adapted for providing fluidic connections. The interconnection strip is realized as a stack of two or more bonded metal sheets and comprises a first planar coupling member at the interconnection strip's first end, the first planar coupling member comprising a first fluid port, a second planar coupling member at the interconnection strip's second end, the second planar coupling member comprising a second fluid port, a fluid conduit adapted for fluidically connecting the first fluid port and the second fluid port.

A method for manufacturing a fluidic device for providing fluidic connections is discloses, the fluidic device comprising a planar coupling member. According to embodiments of the present invention, the method comprises microstructuring one or more metal sheets; stacking the microstructured metal sheets; bonding the metal sheets by subjecting the metal sheets to a joining technique to form a multilayer structure.

According to a preferred embodiment, diffusion welding is used as a joining technique for bonding the metal sheets.

A method for fluidically connecting a first fluidic device and a second fluidic device is disclosed, each of the first and the second fluidic device comprising a fluid conduit and a planar coupling member with a fluid port, the fluid port being fluidically connected with the fluid conduit. According to embodiments of the present invention, the method comprises aligning the planar coupling member of the first fluidic device with the planar coupling member of the second fluidic device in a clamping device and pressing the planar coupling member of the first fluidic device against the planar coupling member of the second fluidic device, whereby a fluidic connection is established between the fluid port of the first fluidic device and the corresponding fluid port of the second fluidic device.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a connecting piece with a planar coupling member according to an embodiment of the present invention;

FIG. 2 illustrates how fluidic connections are established between a first and a second planar coupling member;

FIG. 3 depicts two planar coupling members, with each planar coupling member comprising five fluid ports;

FIG. 4 shows a clamping device for clamping two planar coupling members;

FIG. 5 shows a clamping device with a bell-crank lever;

FIG. 6 shows various fluidic devices made of a stack of metal sheets;

FIG. 7 illustrates how an inner contour of a cut-out is used for aligning two planar coupling members;

FIG. 8 shows an assembly of three planar coupling members;

FIG. 9 illustrates how different flow paths may be established between two planar coupling members;

FIG. 10 illustrates how the planar coupling technique according to embodiments of the present invention can be used for realizing a switching valve;

FIG. 11 shows clamping devices that provide a fluidic coupling between a planar coupling member and a conventional capillary;

FIG. 12 depicts a planar coupling member adapted for providing a fluidic connection with a detection cell; and

FIG. 13 shows a planar coupling member adapted for providing a fluidic connection with an inlet of a separation column.

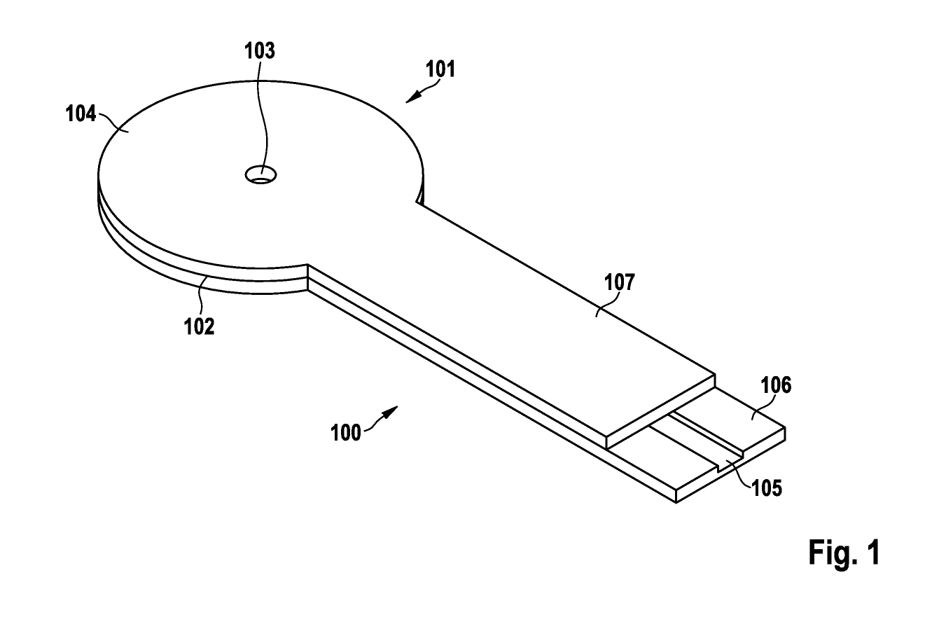

FIG. 1 shows a connecting piece 100 of a fluidic device according to an embodiment of the present invention. The connecting piece 100 protrudes laterally from the fluidic device and comprises a planar coupling member 101. The planar coupling member 101 has a circular contour 102 and comprises a fluid port 103 located at the center of a contact surface 104. Hence, the location of the fluid port 103 is in a predefined relationship with the contour 102 of the planar coupling member 101. The fluid port 103 is fluidically connected with a fluid channel 105 that provides a fluidic connection between the fluid port 103 and the fluidic device.

The planar coupling member 101 is adapted for being pressed against another planar coupling member of another fluidic device. Thus, a fluidic connection is established between the fluid ports of the two planar coupling members.

The connecting piece 100 and the planar coupling member 101 may for example be realized as a multilayer structure comprising two or more bonded plastic sheets or metal sheets. For example, the planar structure shown in FIG. 1 is made of two metal sheets, a lower metal sheet 106 and an upper metal sheet 107. The metal sheets 106, 107 may for example be titanium sheets or stainless steel sheets with a thickness of about 0.05 mm up to single digit millimeter regions. For processing the metal sheets 106 and 107, techniques like e.g. electrochemical or chemical milling may be employed. Electrochemical or chemical milling may e.g. be used for forming the outer contour of the metal sheets, or for forming the fluid channel 105, or for forming both the outer contour and the fluid channel. Alternatively, the fluid channel 105 may be formed by cutting a groove into the lower metal sheet 106. Further alternatively, the fluid channel 105 may be formed by using a stamping process. The fluid port 103 is formed by cutting a via hole into the upper metal sheet 107.

After the metal sheets 106, 107 have been processed, the upper metal sheet 107 is bonded with the lower metal sheet 106.

According to a first embodiment, diffusion welding is used for bonding the metal sheets. In diffusion welding, a multilayer structure comprising two or more stacked metal sheets is put in a vacuum oven for several hours, whereby the metal sheets are pressed against one another with a contact pressing force. Preferably, the stack of metal sheets is subjected to a temperature below the melting point, and preferably to a temperature between 400° C. and 1050° C. depending on the metals to be bonded. By applying heat, vacuum and a contact pressing force to the stack of metal sheets, diffusion of the metal atoms is enhanced, and strong covalent bonds are formed between adjacent metal sheets. As a result, a multilayer structure with a fluid tight fluidic channel 105 is obtained.

According to a second embodiment, the metal sheets 106, 107, which may for example be made of titanium or stainless steel, are electroplated before being bonded. Preferably, the metal sheets 106, 107 are electroplated with a noble metal, like e.g. gold, platinum, palladium, or with nickel. Then, after electroplating has been performed, the plated metal sheets are subjected to diffusion welding as described above. When using electroplated sheets, the bonding temperature may be lower than the bonding temperature used in the first embodiment. Another advantage of using electroplated sheets is that a chemically inert surface is obtained along the fluid channel 105.

According to a third embodiment, at least one surface of the metal sheets 106, 107 is coated with plastic material, or with a hot-melt adhesive. Alternatively, a thin plastic foil may be placed between the metal sheets 106, 107. Then, the metal sheets are stacked, exposed to heat and pressed together for a certain period of time. After the plastic material or the hot-melt adhesive has been exposed to heat, a robust multilayer structure is obtained. When coating the metal sheets with plastic material, the thickness of the coating must not be too thick, because otherwise plastic material may block the fluid channel 105.

Optionally, a further step of modifying the inner surface of the fluid channel 105 may be carried out. For example, in case the fluidic device is applied in the field of analyzing biochemical compounds, a fluid containing biochemical moieties like for example proteins, RNA, DNA, etc. may pass through the fluid channel 105. To prevent adhesion of these biochemical compounds, a step of modifying the inner surface of the fluid channel 105 may be carried out. For example, to prevent adhesion, the inner surface of the fluid channel 105 may be coated with gold, palladium, platinum or any other noble metal, whereby an electroplating technique or an electroless plating technique may be applied. Alternatively, a chemical surface modification of the fluid channel's inner surface may be carried out.

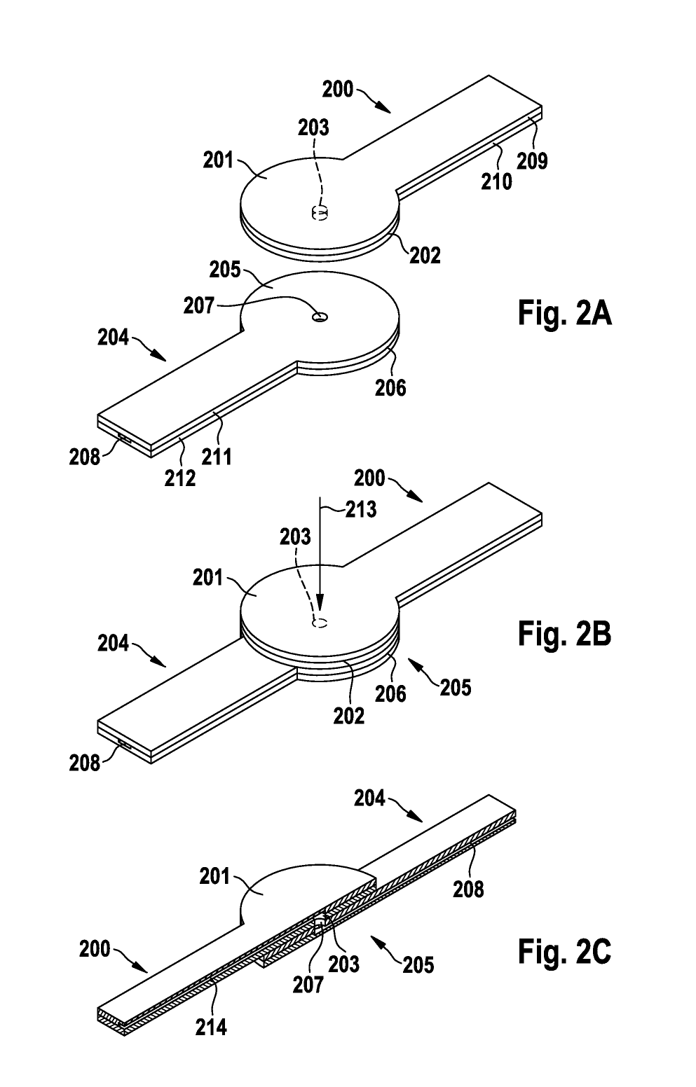

In FIGS. 2A to 2C, it is shown how a fluidic connection is established between a first connecting piece 200 and a second connecting piece 204. The first connecting piece 200 may for example be attached to a first fluidic device, and the second connecting piece 204 may for example be attached to a second fluidic device.

As shown in FIG. 2A, the first connection piece 200 comprises a first planar coupling member 201 having a circular contour 202. The first planar coupling member 201 comprises a fluid port 203 (indicated with dashed lines) located at the bottom side of the first planar coupling member 201. The fluid port 203 is fluidically coupled with a fluid conduit that extends through the connecting piece 200. The location of the fluid port 203 has a predefined relationship to the contour 202 of the first planar coupling member 201. In the example of FIG. 2A, the fluid port 203 is located at the center of the circular contour 202.

The second connecting piece 204 comprises a second planar coupling member 205 having a circular contour 206 that corresponds to the circular contour 202 of the first planar coupling member 201. A fluid port 207 located at the upper side of the second planar coupling member 205 is fluidically coupled with a fluid conduit 208 that extends through the second connecting piece 204. The relationship between the location of the fluid port 207 and the circular contour 206 is also defined by said predefined relationship.

Both the first connecting piece 200 and the second connecting piece 204 are realized as a stack of two or more bonded metal sheets. The first connecting piece 200 is composed of an upper sheet 209 and a lower sheet 210. Correspondingly, the second connecting piece 204 is composed of an upper sheet 211 and a lower sheet 212.

In FIG. 2B, it is shown how the first connecting piece 200 is fluidically coupled with the second connecting piece 204. For this purpose, the contour 202 of the first planar connecting member 201 is aligned with the corresponding contour 206 of the second planar coupling member 205. Furthermore, the first planar coupling member 201 is pressed against the second planar coupling member 205 with a certain contact pressing force 213.

Because of the predefined relationship between the respective locations of the fluid ports 203, 207 and the corresponding contours 202, 206, an alignment of the contours 202 and 206 will lead to a corresponding alignment of the fluid ports 203 and 207. By aligning the two planar coupling members 201 and 205, the fluid ports 203 and 207 are aligned as well. Thus, a fluidic coupling between the fluid ports 203 and 207 is established, whereby the respective contact surfaces of the first and the second planar coupling member 201 and 205 are adapted for sealing the fluidic connection. For accomplishing a fluid-tight fluidic connection, the area of these contact surfaces should not be too small. Furthermore, the magnitude of the contact pressing force 213 has to be sufficiently large for sealing the fluidic connection. The contact pressing force 213 may for example be exerted by a suitable clamping device.

FIG. 2C shows a cross section of both the first connecting piece 200 and the second connecting piece 204, wherein the contour 202 of the first planar coupling member 201 is aligned with the corresponding contour 206 of the second planar coupling member 205. As a consequence, the fluid port 203 is aligned with the fluid port 207, and via the two fluid ports 203, 207, a fluidic connection is established between the fluid conduit 214 and the fluid conduit 208. Hence, the fluidic coupling technique depicted in FIGS. 2A to 2C is capable of providing fluid-tight fluidic connections between a first and a second fluidic device.

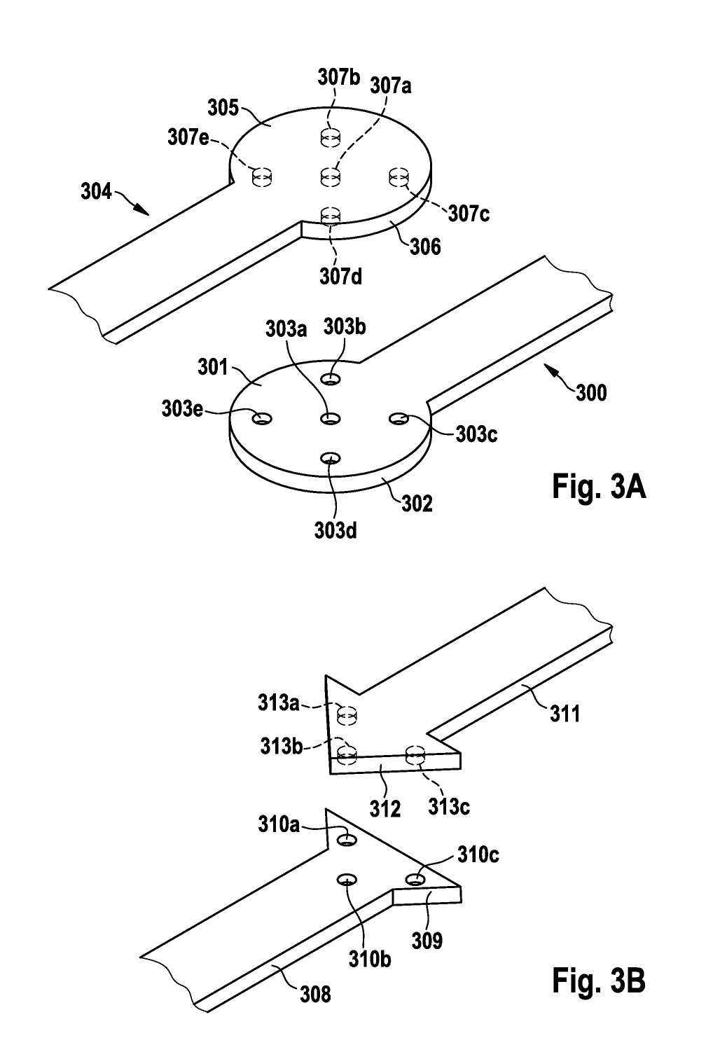

In FIGS. 3A and 3B, two different types of planar coupling members are depicted. FIG. 3A shows a connecting piece 300 with a planar coupling member 301 having a circular contour 302, whereby the planar coupling member 301 comprises five fluid ports 303a to 303e. Each of the fluid ports 303a to 303e is fluidically coupled with a dedicated fluid channel that extends through the connecting piece 300. The five fluid ports 303a to 303e are arranged according to a predefined pattern: the fluid port 303a is located at the center of the planar coupling member 301, and the other fluid ports 303b to 303e are arranged on a circle around the central fluid port 303a in a regular manner. Hence, the respective locations of each of the fluid ports 303a to 303e are in a predefined relationship with the contour 302 of the planar coupling member 301. A complementary connecting piece 304 comprises a planar coupling member 305 having a circular contour 306 that corresponds to the circular contour 302 of the planar coupling member 301. The fluid ports 307a to 307e of the planar coupling member 305, which are located at the bottom side of the planar coupling member 305 (indicated with dashed lines), are arranged according to the same pattern as the corresponding fluid ports 303a to 303e. Accordingly, when the planar coupling member 305 is aligned with the planar coupling member 301 in a way that the contour 306 matches with the contour 302 and the orientation of the connecting piece 304 corresponds to the orientation of the connecting piece 300, fluidic connections are established between the fluid port 303a and the corresponding fluid port 307a, between the fluid port 303b and the corresponding fluid port 307b, etc. Thus, five fluidic connections may be established simultaneously between the connecting piece 300 and the connecting piece 304.

To provide for an unambiguous alignment, planar coupling members with a polygonal contour may e.g. be employed. For example, FIG. 3B shows a connecting piece 308 that comprises a planar coupling member 309 having a triangular contour. The planar coupling member 309 comprises three fluid ports 310a to 310c arranged in a predefined pattern. The complementary connecting piece 311 comprises a planar coupling member 312 having a corresponding triangular contour, with three fluid ports 313a to 313c (indicated with dashed lines) being located at the bottom side of the planar coupling member 312. The fluid ports 313a to 313c are arranged according to the same predefined pattern as the corresponding fluid ports 310a to 310c. When the contour of the planar coupling member 309 is aligned with the corresponding contour of the planar coupling member 312, the positions of the fluid ports 310a to 310c match with the positions of the corresponding fluid ports 313a to 313c. As a result, three fluidic connections are established between the connecting pieces 308 and 311. The triangular contour of the planar coupling members 309 and 312 simplifies the alignment of the planar coupling members.

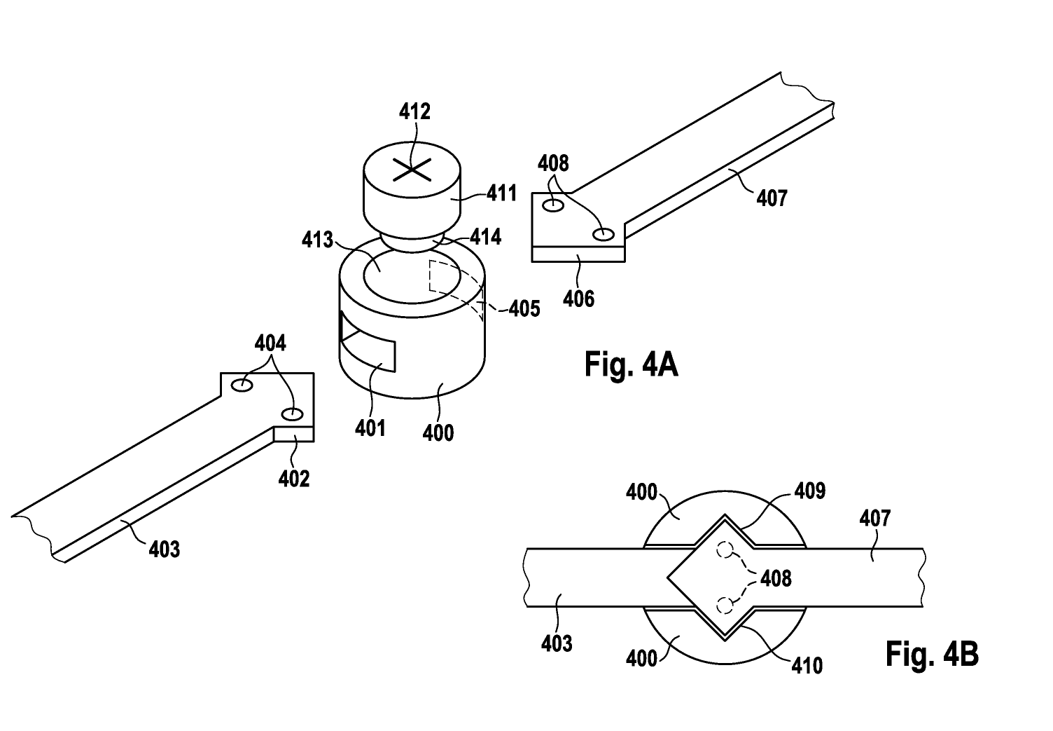

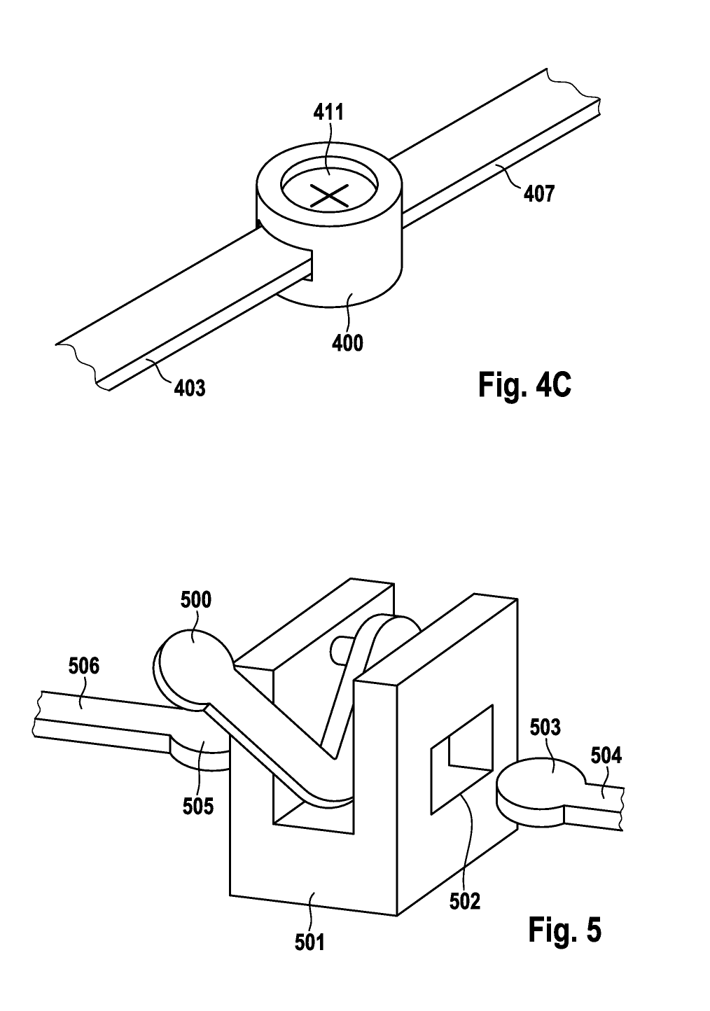

The contact pressing force for pressing a first planar coupling member against a second planar coupling member may for example be exerted by a clamping device. As shown in FIG. 4A, the clamping device 400 comprises a first opening 401 for inserting a first planar coupling member 402 of a first connecting piece 403. In the embodiment shown in FIG. 4, the planar coupling member 402 has a rhombic contour and comprises two fluid ports 404 located at the upper side of the planar coupling member. The clamping device 400 further comprises a second opening 405 for inserting a second planar coupling member 406 of a second connecting piece 407. The second planar coupling member 406 has a rhombic contour and comprises two fluid ports 408 (indicated with dashed lines) located at its bottom side. In the interior of the clamping device 400, the second fluidic coupling member 406 is positioned on top of the first planar coupling member 402. As shown in FIG. 4B, the interior of the clamping device 400 comprises fitting surfaces 409, 410 that correspond to the rhombic contour of the planar coupling members 402 and 406. The fitting surfaces 409 and 410 enforce an exact alignment of the planar coupling members 402 and 406. As a consequence, the positions of the fluid ports 404 are brought into agreement with the positions of the corresponding fluid ports 408.

For fastening the planar coupling members 402 and 406, a grub screw 411 with a cross recess 412 is screwed into a corresponding internally threaded bore hole 413. When the grub screw 411 is tightened, the lower end 414 of the grub screw 411 presses the second planar coupling member 406 against the first planar coupling member 402, and fluid-tight fluidic connections are established between the fluid ports 404 and the corresponding fluid ports 408. The contact pressing force exerted by the grub screw 411 has to be sufficiently large to prevent leakage of the fluidic connections.

FIG. 4C shows the clamping device 400 together with the first connection piece 403 and the second connecting piece 407 after the grub screw 411 has been tightened. The clamping connection between the first and the second connecting piece 403 and 407 is realized as a detachable fluidic connection. For detaching the fluidic connection, the grub screw 411 is untightened, and then, the first and the second connecting piece 403 and 407 can be pulled out of the clamping device 400.

Alternatively, the contact pressing force for pressing a planar coupling member against another planar coupling member may for example be generated by one of: a wedge, a clamp lever, a bent lever, a bell-crank lever, a hydraulic cylinder. For example, by using a hydraulic cylinder for clamping the first and the second planar coupling member, the clamping operation may be automated.

FIG. 5 shows an embodiment in which a bell-crank lever 500 is pivotably mounted on a clamping device 501. The clamping device 501 comprises a first opening 502 for inserting a first planar coupling member 503 of a first connecting piece 504, and a second opening for inserting a second planar coupling member 505 of a second connecting piece 506. By depressing the bell-crank lever 500, the first planar coupling member 503 is pressed against the second planar coupling member 505, whereby one or more fluid-tight fluidic connections are established. For detaching the fluidic connection between the first and the second connecting piece 504 and 506, the bell-crank lever 500 is pulled in the upward direction.

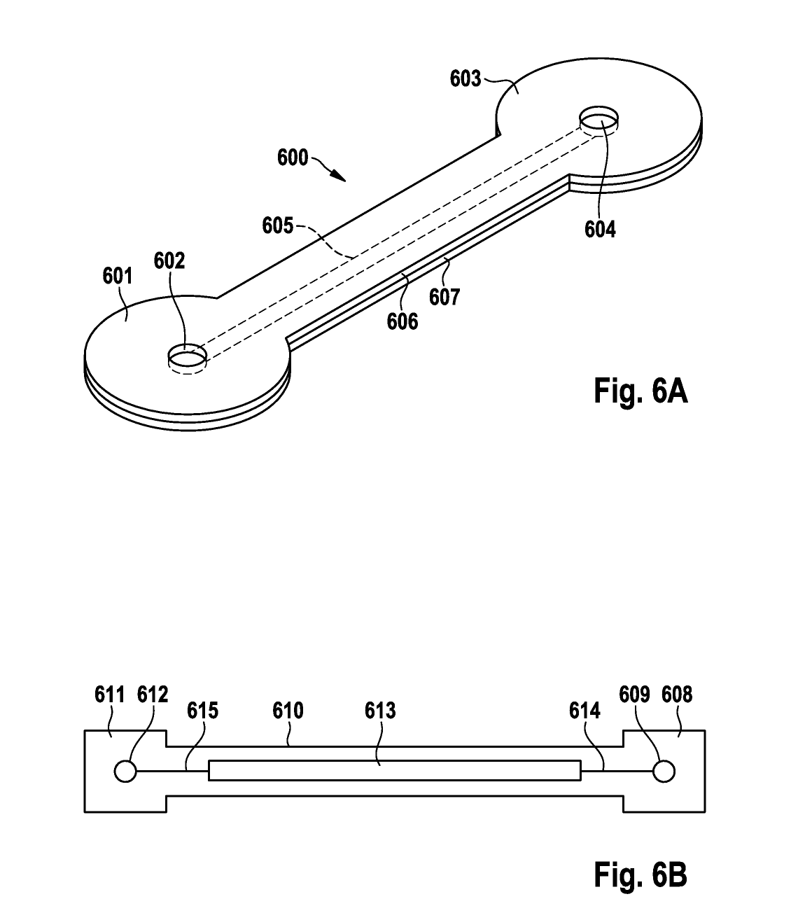

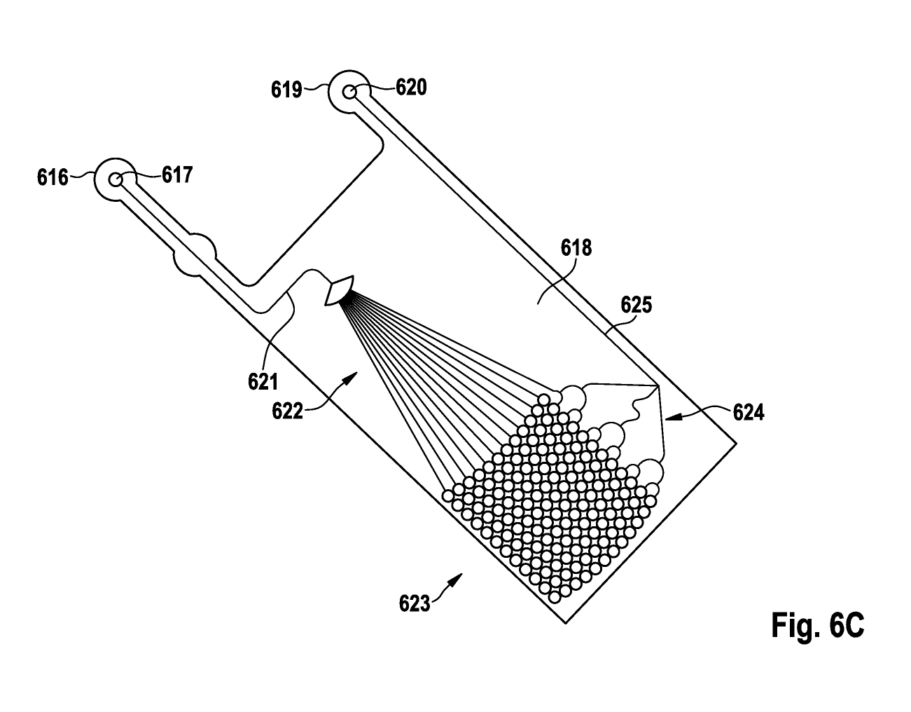

So far, it has been described that connecting pieces adapted for fluidically coupling different fluidic devices can be realized using the above-described planar fluidic coupling technique. However, the planar fluidic coupling technique may as well be employed for realizing not only the connecting pieces, but a fluidic device as a whole. In FIGS. 6A to 6C, three different examples of planar fluidic devices are given. FIG. 6A shows an interconnection strip 600 that comprises a first planar coupling member 601 with a first fluid port 602 and a second planar coupling member 603 with a second fluid port 604. Within the interconnection strip 600, a fluid conduit 605 extends from the first fluid port 602 to the second fluid port 604 and provides a fluidic connection between the two fluid ports 602, 604.

An interconnection strip of the type shown in FIG. 6A may be implemented as a stack of two or more bonded metal sheets, with the fluid conduit 605 being realized as a groove, and with the fluid ports 602, 604 being realized as via holes. In particular, the interconnection strip 600 shown in FIG. 6A is composed of an upper metal sheet 606 and a lower metal sheet 607 which are bonded by a diffusion welding process.

The interconnection strip 600 of FIG. 6A may be used for providing a fluidic connection between two fluidic components. For this purpose, the first planar coupling member 601 may be clamped together with a corresponding planar coupling member of a first fluidic component, and the second planar coupling member 603 may be clamped together with a corresponding planar coupling member of a second fluidic component. As a result, the two fluidic components are fluidically interconnected via the first fluid port 602, the fluid conduit 605 and the second fluid port 604. Hence, the interconnection strip 600 can be used instead of a conventional glass capillary for interconnecting fluidic components. In fact, the interconnection strip 600 may be seen as a “planar capillary” that provides the functionality of a glass capillary.

Compared to a glass capillary, the interconnection strip 600 shown in FIG. 6A offers several advantages: first of all, the interconnection strip 600 is composed of metal sheets and therefore, it is more robust than a conventional glass capillary. In particular, the fluid conduit 605 may withstand fluid pressures of 1500 bar or more. Furthermore, the planar fluidic coupling technique according to embodiments of the present inventions offers significant advantages compared to conventional capillary fittings. By pressing a first planar coupling member against a second planar coupling member, a direct fluidic contact is established between a fluid port of the first planar coupling member and the corresponding fluid port of the second planar coupling member. Hence, the dead volume of this fluidic connection is considerably smaller than the dead volume of a conventional capillary fitting. In microfluidics, fluid volumes exchanged between microfluidic components become smaller and smaller, and hence, reducing dead volume is an important issue.

FIG. 6B shows how a separation column can be implemented as a planar fluidic device according to an embodiment of the present invention. The fluidic device, which is composed of two ore more metal sheets, comprises a first planar coupling member 608 with a first fluid port 609, a column section 610, and a second planar coupling member 611 with a second fluid port 612. The column section 610 comprises a separation column 613 that may for example be filled with some kind of packing material. Via a first fluid conduit 614, the first fluid port 609 is fluidically coupled with an inlet of the separation column 613, and via a second fluid conduit 615, the outlet of the separation column 613 is fluidically connected with the second fluid port 612. The fluidic device shown in FIG. 6B may be realized as a stack of two or more microstructured metal sheets.

For integrating the separation column shown in FIG. 6B into a separation system, the planar coupling member 608 may for example be connected with a sample injection unit and/or with a solvent pump. The second planar coupling member 611 may be connected with a detection unit adapted for detecting sample compounds that have been separated during their passage through the separation column 613. By employing a planar fluidic coupling technique according to embodiments of the present invention, the planar fluidic device of FIG. 6B can be easily replaced whenever this is necessary.

FIG. 6C shows a heat exchanger that is implemented as a planar fluidic device according to embodiments of the present invention. The heat exchanger comprises a first planar coupling member 616 with a first fluid port 617, a planar heat exchanging section 618, and a second planar coupling member 619 with a second fluid port 620. A supply line 621 that is fluidically connected with the first fluid port 617 branches out into a plurality of feed lines 622 that supply fluid to an array of heat exchange cells 623. The array of heat exchange cells 623 may for example be located in the vicinity of one of: a heating unit, a cooling unit, a Peltier element. After the fluid has been brought to a desired temperature, it is drained off via a plurality of discharge lines 624. The discharge lines 624 are fluidically connected, via a discharge pipe 625, with the second fluid port 620. At the second fluid port 620, fluid of the desired temperature can be obtained.

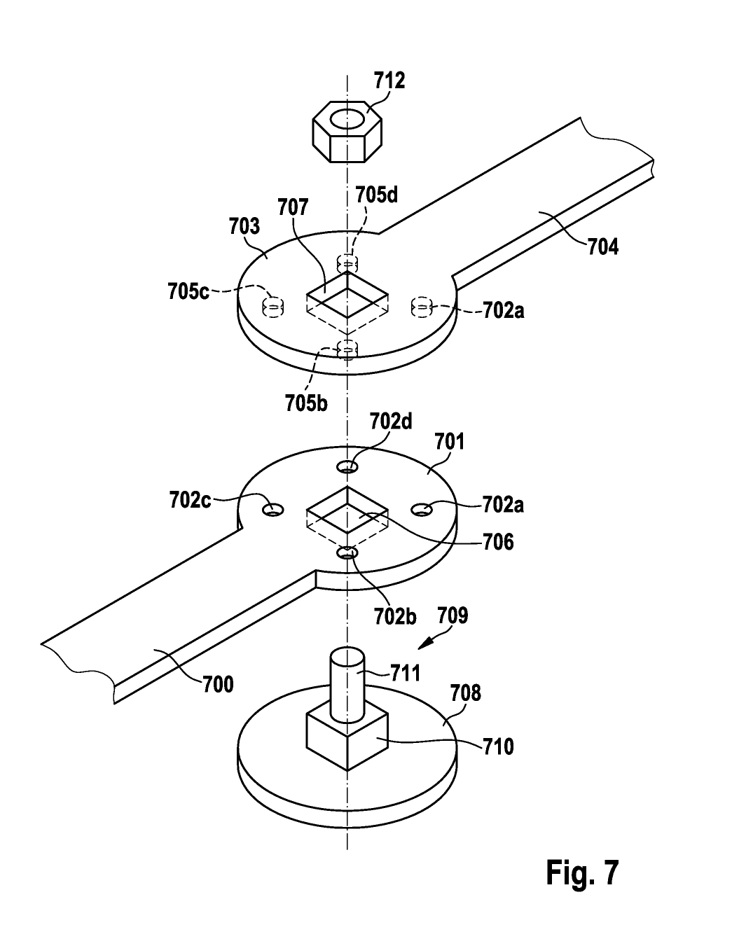

FIG. 7 shows another embodiment of the planar fluidic coupling technique. A first connecting piece 700 comprises a first planar coupling member 701 with four fluid ports 702a to 702d located at the upper side of the first planar coupling member 701. The first planar coupling member 701 is adapted for establishing fluidic connections with a second planar coupling member 703 of a second connecting piece 704. The second planar coupling member 703 comprises four fluid ports 705a to 705d (indicated with dashed lines), which are located at the bottom side of the second planar coupling member 703.

As shown in FIG. 7, the first planar coupling member 701 comprises a square cut-out 706 located at the planar coupling member's center, and the second planar coupling member 703 also comprises a square cut-out 707 that is identical with the cut-out 706. In the embodiments that have been described so far, the outer contour of the planar coupling members has been used for aligning the planar coupling members. In contrast, in the embodiment shown in FIG. 7, the inner contour of the cut-outs 706 and 707 is used for aligning the first connecting piece 700 with the second connecting piece 704. For example, a clamping device 708 adapted for clamping both the first and the second planar coupling member 701 and 703 may comprise a pin 709, with the lower part 710 of the pin 709 having a square cross section that corresponds to the square cut-outs 706 and 707. The upper part 711 of the pin 709 comprises an external thread. When the first planar coupling member 701 and the second planar coupling member 703 are plugged onto the clamping device 708, the lower part 710 of the pin 709 engages with the cut-outs 706 and 707. Thus, the fluid ports 702a to 702d are aligned with the corresponding fluid ports 705a to 705d. A screw nut 712 is screwed onto the upper part 711 of the pin 709 in a way that the planar coupling member 703 is pressed onto the planar coupling member 701 with a sufficient contact pressing force to accomplish fluid-tight fluidic connections between the respective fluid ports.

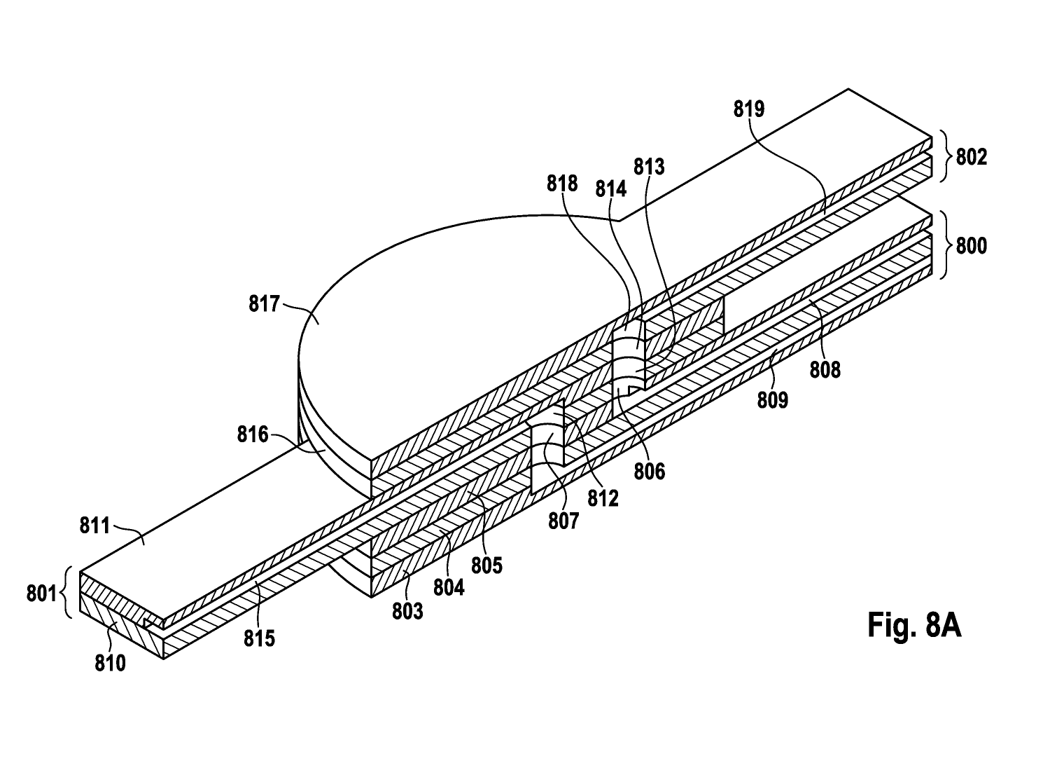

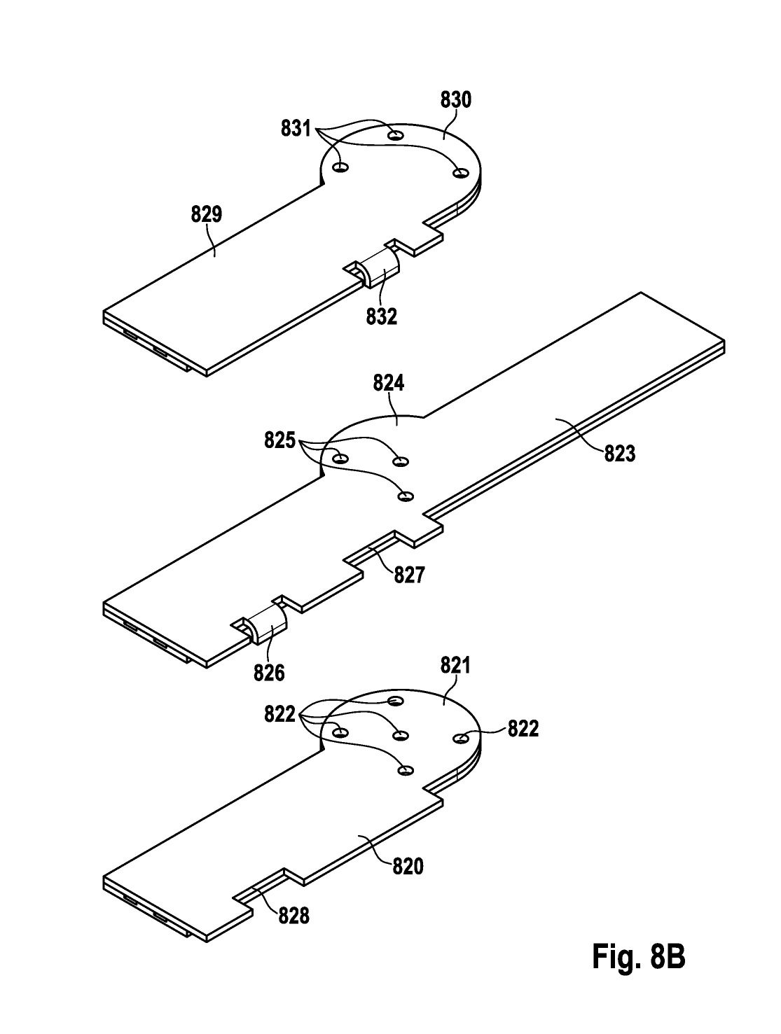

So far, fluidic coupling between two connecting pieces has been discussed. However, for realizing more complex flow paths, the planar fluidic coupling technique according to embodiments of the present invention may also be used for fluidically coupling three or more connecting pieces. An example is shown in FIG. 8A, where a first connecting piece 800, a second connecting piece 801 and a third connecting piece 802 are clamped together. The first connecting piece 800 is made of three metal sheets 803, 804, 805 and comprises two fluid ports 806, 807 located at the upper side. Fluid port 806 is fluidically connected with a channel 808, and fluid port 807 is fluidically coupled with a channel 809.

The second connecting piece 801 is made of two metal sheets 810 and 811. It comprises two fluid ports 812, 813 located at its bottom side and one fluid port 814 located at its upper side. The fluid port 812 is fluidically coupled with a channel 815, whereas the fluid ports 813 and 814 form a via hole that extends through the second connecting piece 801. The third connecting piece 802 is made of two metal sheets 816, 817 and comprises a fluid port 818 located at its bottom side, the fluid port 818 being fluidically coupled with a channel 819. For fluidically connecting the connecting pieces 800, 801 and 802, the respective planar coupling members of the connecting pieces are aligned with one another and clamped together. Thus, fluid-tight fluidic connections are established between fluid ports 806 and 813, between fluid ports 807 and 812, and between fluid ports 814 and 818. The channel 809 of the first connecting piece 800 is fluidically coupled with the channel 815 of the second connecting piece 801. Furthermore, the channel 808 of the first connecting piece 800 is fluidically coupled with the channel 819 of the third connecting piece 802.

FIG. 8B shows another embodiment in which the connecting pieces are equipped with interlocking features that enforce a well-defined arrangement of the planar coupling members relative to one another. A first connecting piece 820 comprises a first planar coupling member 821 with fluid ports 822. A second connecting piece 823 comprises a second planar coupling member 824 with fluid ports 825. The second connecting piece 823 further comprises a bent locking member 826 and a recess 827. If the second connecting piece 823 is properly positioned on the first connecting piece 820, the bent locking member 826 engages with a corresponding recess 828 of the first connecting piece 820. The interaction between the bent locking member 826 and the recess 828 provides for a correct alignment of the first connecting piece 820 and the second connecting piece 823. A third connecting piece 829 comprises a third planar coupling member 830 with fluid ports 831. The third connecting piece 829 further comprises a bent locking member 832. When the third connecting piece 829 is properly aligned with the second connecting piece 823, the bent locking member 832 engages with the corresponding recess 827 of the second connecting piece 823. Hence, the bent locking member 832 and the corresponding recess 827 ensure a correct alignment of the third connecting piece 829 relative to the second connecting piece 823 and the first connecting piece 820. In particular, it is prevented that the connecting pieces 820, 823 and 829 are assembled in a wrong way.

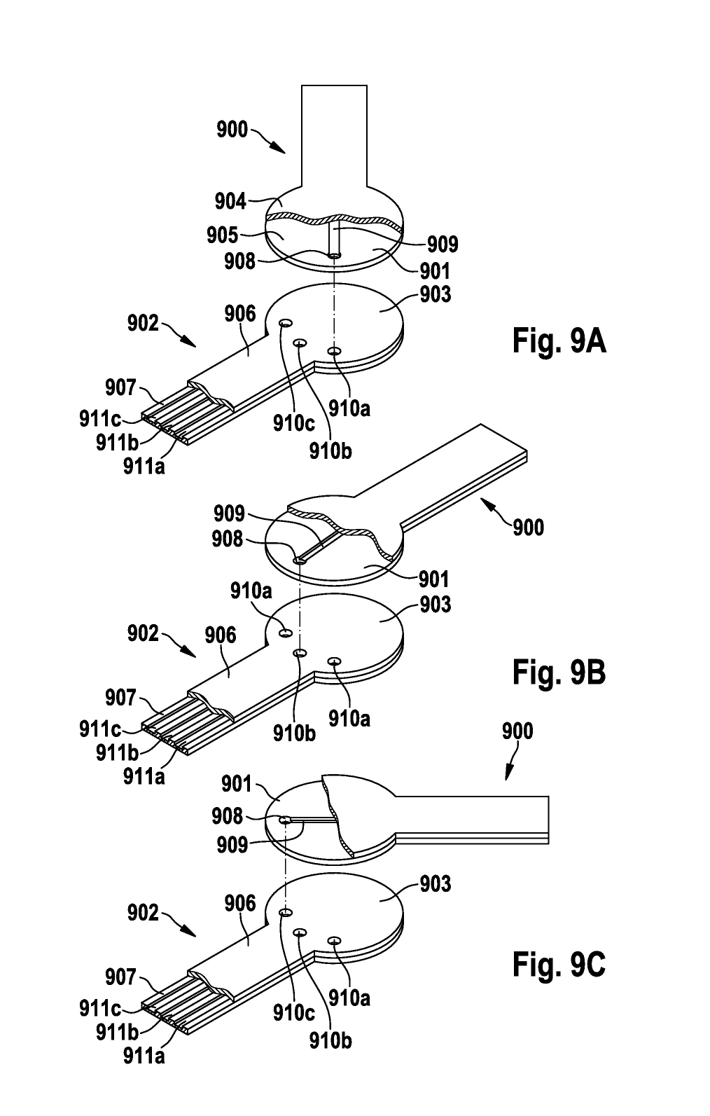

In FIGS. 9A to 9C, it is shown how a first connecting piece 900 with a first planar coupling member 901 may be fixed to a second connecting piece 902 with a second planar coupling member 903 at different possible orientations, whereby in each of the different possible orientations, different fluidic connections are established between the first planar coupling member 901 and the second planar coupling member 903. As shown in FIG. 9A, the first connecting piece 900 is composed of an upper metal sheet 904 and a lower metal sheet 905. The second planar coupling member 902 is made of an upper metal sheet 906 and a lower metal sheet 907. Preferably, both the first planar coupling member 901 and the second planar coupling member 903 have a circular contour, which allows fixing the first planar coupling member 901 at different orientations relative to the second planar coupling member 903. The first planar coupling member 901 comprises a fluid port 908 located at its bottom surface, the fluid port 908 being fluidically connected with a channel 909. The upper surface of the second planar coupling member 903 comprises three fluid ports 910a, 910b, and 910c. Each of the fluid ports 910a, 910b, and 910c is fluidically connected with a corresponding channel 911a, 911 b, 911c that extends through the second connecting piece 902.

In FIG. 9A, the first connecting piece 900 is fixed at a first orientation relative to the second connecting piece 902. In this first orientation, the location of the fluid port 908 matches with the location of the fluid port 910a. Thus, a fluidic connection is established between the channel 909 of the first connecting piece 900 and the channel 911a of the second connecting piece 902.

In FIG. 9B, the first connecting piece 900 is set to another orientation relative to the second connecting piece 902. Now, the location of the fluid port 908 matches with the location of the fluid port 910b. By pressing the first planar coupling member 901 against the second planar coupling member 903, a fluid-tight fluidic connection is established between the channel 909 of the first connecting piece 900 and the channel 911b of the second connecting piece 902.

In FIG. 9C, the first connecting piece 900 is fixed at a third orientation relative to the second connecting piece 902, whereby a fluid-tight fluidic connection is established between the fluid port 908 and the fluid port 910c. In this third orientation, the channel 909 is fluidically connected with the channel 911c.

By fixing the first connecting piece 900 relative to the second connecting piece 902 at one of the positions shown in FIGS. 9A, 9B and 9C, it is possible to select between different flow paths. For example, the channels 911a, 911b and 911c may have different cross sections. By choosing one of the three possible orientations of the first connecting piece 900 relative to the second connecting piece 902, a channel with an appropriate cross section may be selected.

The embodiment illustrated in FIGS. 9A to 9C may for example be used for selecting a suitable flow path during assembly of the fluidic components. Alternatively, the embodiment shown in FIGS. 9A to 9C may be employed for switching between different flow paths during operation of the fluidic system. In this case, a clamping device for pressing the first planar coupling member 901 against the second planar coupling member 903 may be adapted for automatically tightening and untightening the clamping connection. For example, the clamping device may comprise a pneumatic cylinder, a hydraulic cylinder, or any other kind of actuation mechanism adapted for pressing the first planar coupling member 901 against the second planar coupling member 903. Furthermore, the clamping device may for example comprise an actuation mechanism adapted for moving the first connecting piece 900 to different positions relative to the second connecting piece 902.

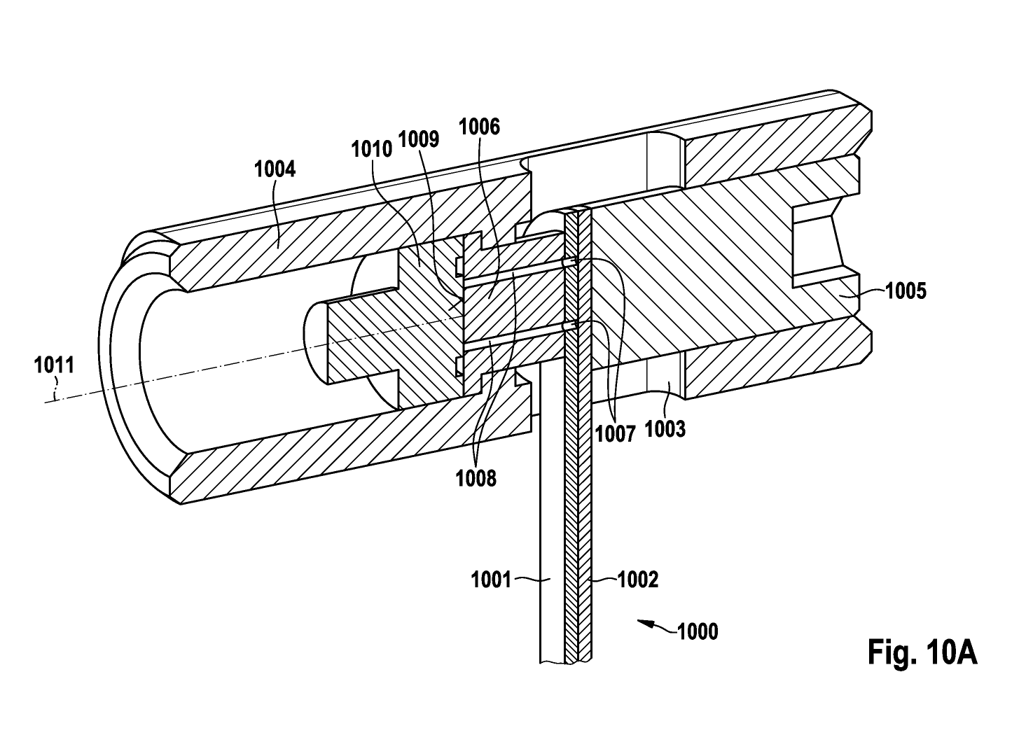

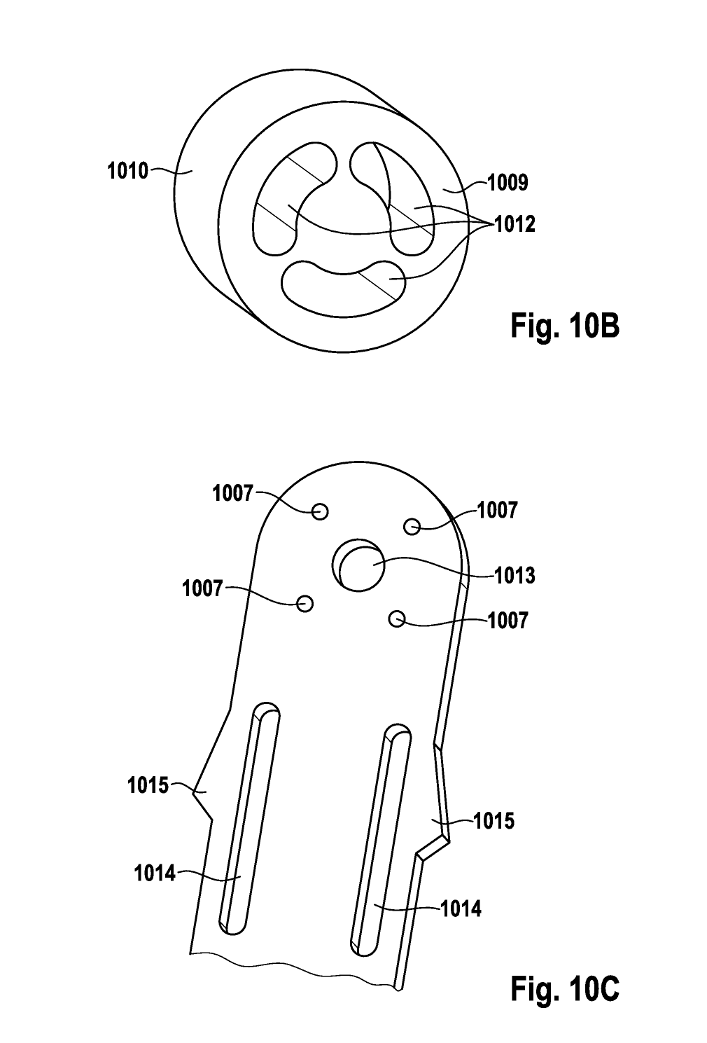

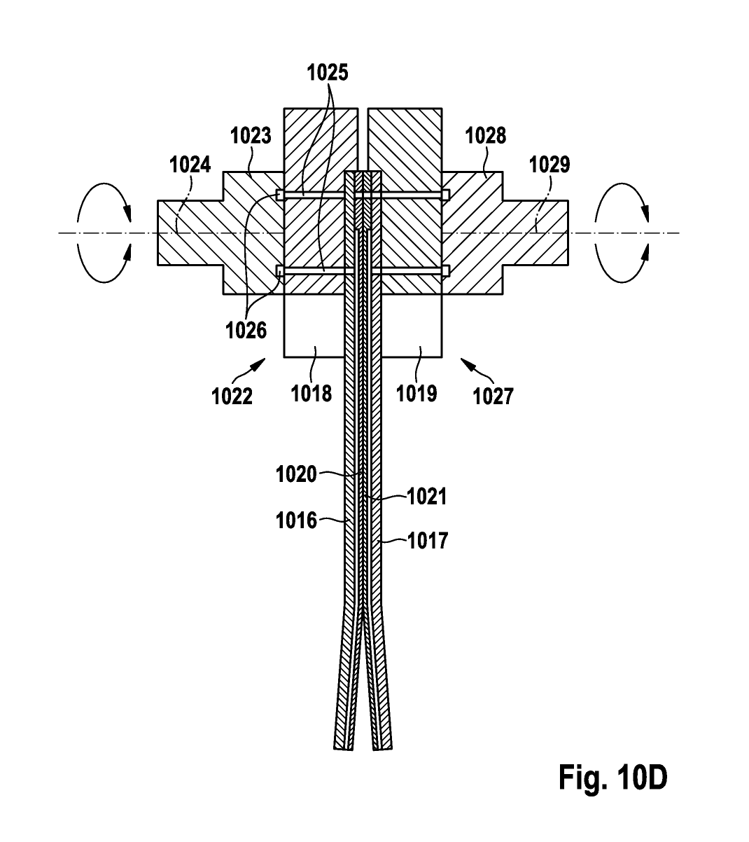

In FIGS. 10A to 10D, it is shown how the planar coupling technique that has been described so far may be combined with a rotor element, in order to realize a switching valve. A planar connecting piece 1000 that is made of an upper metal sheet 1001 and a lower metal sheet 1002 is inserted, via a cut-out 1003, into a clamping device 1004. The clamping device 1004 comprises a hexagon socket set screw 1005. By tightening the set screw 1005, the upper end of the planar connecting piece 1000 is pressed against the rear face of a stator element 1006. Thus, fluidic connections are established between fluid ports 1007 located at the upper side of the connecting piece 1000 and corresponding fluid channels 1008 that extend through the stator element 1006. The front face of the stator element 1006 is in direct contact with a surface 1009 of a rotor element 1010, whereby the rotor element 1010 may be pivoted around an axis of rotation 1011.

FIG. 10B gives a detailed view of the bottom surface 1009 of the rotor element 1010. The bottom surface 1009 comprises a plurality of switching channels 1012, which may for example be realized as grooves. The switching channels 1012 are adapted for providing fluidic connections between adjacent fluid channels 1008. By setting the rotor element 1010 to different positions relative to the stator element 1006, different flow paths may be set up between the fluid ports 1007 of the planar connecting piece 1000. Hence, by rotating the rotor element 1010 of the switching valve, switching between different flow paths may be effected.

FIG. 10C gives a more detailed view of the planar connecting piece 1000. The planar connecting piece 1000 may e.g. comprise four fluid ports 1007. Furthermore, the planar connecting piece 1000 may comprise different features for aligning the planar connecting piece 1000 with the clamping device 1004. For example, the planar connecting piece 1000 may comprise a hole 1013 that is adapted for engaging with a corresponding protrusion. The planar connecting piece 1000 may further comprise respective slots 1014 and detents 1015 for fixing the planar connecting piece 1000 at a predefined position relative to the stator element 1006.

In the embodiment shown in FIG. 10D, two connecting pieces 1016, 1017 are clamped between a first stator element 1018 and a second stator element 1019. Each of the first connecting piece 1016 and the second connecting piece 1017 is composed of two bonded metal sheets. The first connecting piece 1016 comprises a channel 1020, and the second connecting piece 1017 comprises a channel 1021. The first switching valve 1022 comprises, in addition to the stator element 1018, a rotor element 1023 that is pivotably mounted on the stator element 1018. The rotor element 1023 may be rotated around an axis of rotation 1024. The stator element 1018 comprises a set of fluidic channels 1025 that provide fluidic connections between fluid ports of the first connecting piece 1016 and switching channels 1026 of the rotor element 1023. Correspondingly, the second switching valve 1027 comprises, in addition to the second stator element 1019, a rotor element 1028 that may be pivoted around an axis of rotation 1029. The stator element 1019 comprises fluidic channels that provide fluidic connections between fluid ports of the second connecting piece 1016 and switching channels of the rotor element 1028. For switching between different flow paths, at least one of the rotor elements 1023, 1028 is rotated.

The planar coupling technique proposed in embodiments of the present invention is not limited to establishing fluidic connections between two or more planar coupling members. The planar coupling technique may as well be employed for providing fluidic connections between a planar coupling member and a conventional capillary. Capillaries, which may for example be made of glass or stainless steel, are widely used for setting up fluidic connections between fluidic components. The planar coupling technique according to embodiments of the present invention is capable of providing an interoperability between capillaries and planar coupling members.

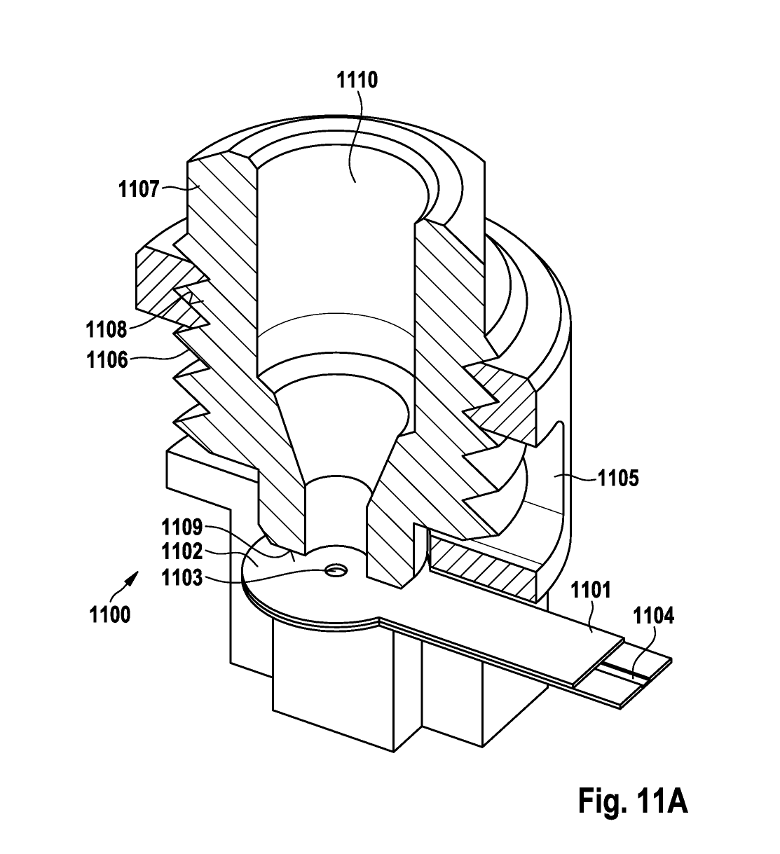

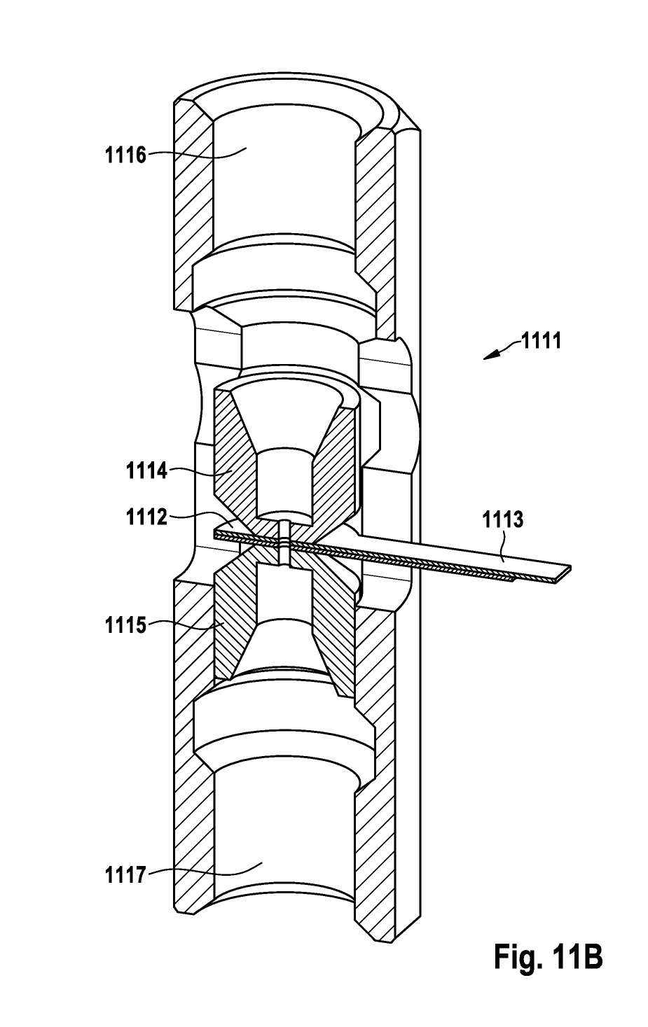

FIG. 11A shows a clamping device 1100 adapted for establishing a fluidic connection between a connecting piece 1101 and a capillary. The connecting piece 1101 may for example be made of two bonded metal sheets. The connecting piece 1101 comprises a planar coupling member 1102 with a fluid port 1103, the fluid port 1103 being fluidically connected with a channel 1104. The clamping device 1100 is adapted for fastening the planar coupling member 1102. The clamping device 1100 comprises a socket component 1105 with an internal thread 1106, and an inner clamping component 1107. The inner clamping component 1107 comprises an external thread 1108 that is adapted for engaging with the socket component's internal thread 1106 when the inner clamping component 1107 is screwed into the socket component 1105. The inner clamping component 1107 comprises a ring-shaped clamping surface 1109. When the inner clamping component 1107 is tightened, the clamping surface 1109 is tightly pressed against the planar coupling member 1102. The inner clamping component 1107 further comprises a fitting 1110 for fastening a capillary. The clamping device 1100 is adapted for providing a fluidic connection between the fluidic channel 1104 of the connecting piece 1101 and a capillary fixed in the fitting 1110.

FIG. 11B shows a clamping device 1111 adapted for clamping a planar coupling member 1112 of a connecting piece 1113 in a way that fluid connections are established with a first capillary and with a second capillary. For this purpose, the planar coupling member 1112 is clamped between a first clamping component 1114 and a second clamping component 1115. The first clamping component 1114 is screwed into the clamping device 1111 from above, whereas the second clamping component 1115 is screwed into the clamping device 1111 from below. The clamping device 1111 further comprises a first fitting 1116 for a first capillary and a second fitting 1117 for a second capillary. A fluid port located at the upper side of the planar coupling member 1112 may be fluidically connected with a first capillary that has been mounted in the first fitting 1116. Correspondingly, a fluid port located at the bottom side of the planar coupling member 1112 may be fluidically coupled with a second capillary mounted in the second fitting 1117.

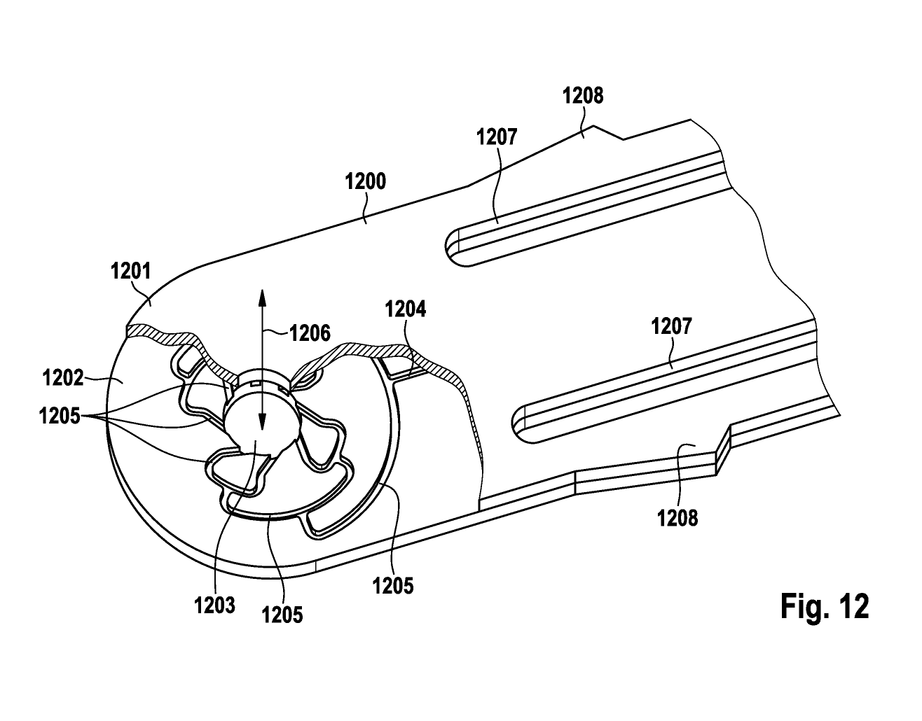

In general, a connecting piece with a planar coupling member may be used for establishing fluidic connections with a variety of fluidic devices. For example, FIG. 12 shows a planar coupling member 1200 for establishing a fluidic connection with a detection cell. The detection cell is adapted for determining a physical property of a fluid passing through the detection cell. The detection cell may e.g. be an optical detection cell for determining an optical property of the fluid, or an electrical detection cell adapted for determining an electrical property of the fluid.

In any case, turbulent flow of the fluid passing though the detection cell may have an impact on the detected physical property. Therefore, when supplying fluid to a detection cell, avoiding turbulent flow is an important issue, because turbulent flow may affect the obtained measurement results.

The planar coupling member 1200 shown in FIG. 12 is made of an upper metal sheet 1201 and a lower metal sheet 1202. Fluid is supplied to the detection cell via a fluid outlet 1203 located at the centre of the planar coupling member 1200. In order to prevent generating turbulent flow, a fluid supply channel 1204 branches out into a plurality of ramified fluid conduits 1205, with each of the ramified fluid conduits 1205 being fluidically coupled with the outlet 1203. Each of the ramified fluid conduits 1205 supplies a fraction of the total flow to the fluid outlet 1203. The ramified fluid conduits 1205 may have different orientations relative to the fluid outlet 1203. The contributions of the ramified fluid conduits 1205 add up to a resulting flow 1206 that is supplied to the detection cell.

The planar coupling member 1200 may further comprise interlocking features that facilitate an alignment of the planar coupling member 1200 relative to the detection cell. For example, the planar coupling member 1200 may comprise slots 1207 and detents 1208 that may engage with complementary features of a clamping device.

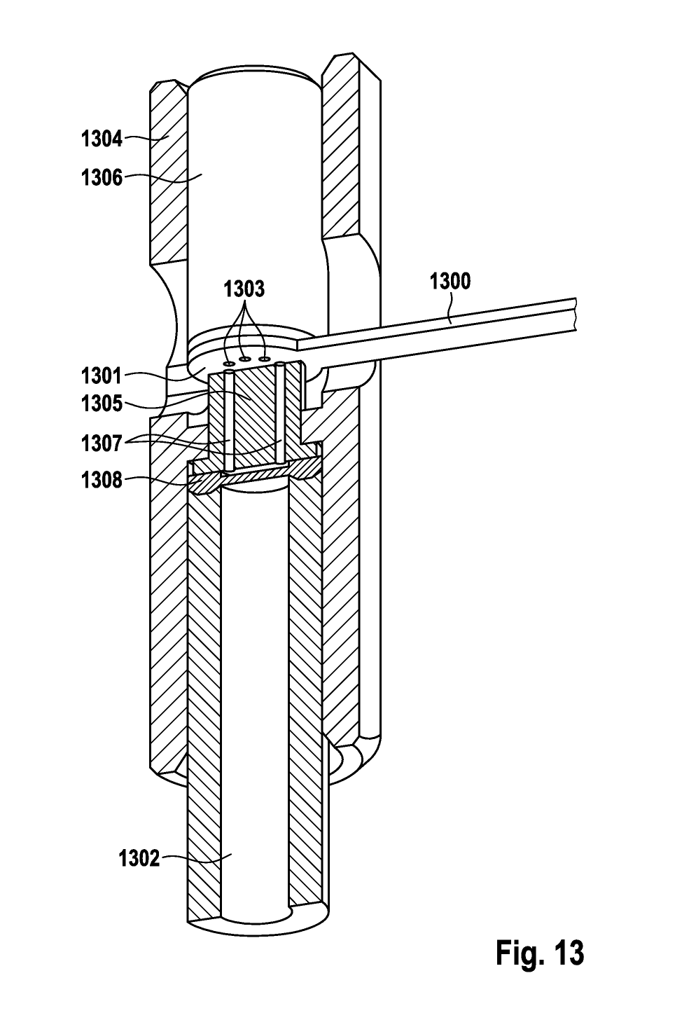

FIG. 13 shows a connecting piece 1300 with a planar coupling member 1301 adapted for supplying fluid to a separation column 1302, wherein the separation column 1302 is adapted for separating compounds of a fluid sample. The separation column 1302 may e.g. be filled with some kind of packing material. To provide for a homogeneous supply of fluid to the inlet of the separation column 1302, the planar coupling member 1301 comprises a plurality of fluid ports 1303.

A clamping device 1304 for fixing the planar coupling member 1301 is located at a first end of the separation column 1302. The planar coupling member 1301 is placed on top of an intermediate piece 1305. Then, a grub screw 1306 is tightened, whereby the lower face of the planar coupling member 1301 is pressed against the intermediate piece 1305. The intermediate piece 1305 comprises a set of fluid channels 1307, whereby the location of the fluid channels 1307 corresponds to the respective locations of the fluid ports 1303. The fluid channels 1307 provide fluidic connections between the fluid ports 1303 and the inlet of the separation column 1302. After the fluid has passed through the fluid channels 1307, it still has to pass through a frith 1308 before passing through the separation column 1302.

1. A fluidic device for providing fluidic connections, the fluidic device comprising
a fluid conduit,
a planar coupling member with a fluid port, the fluid port being fluidically connected with the fluid conduit,
wherein a contour of the planar coupling member is in a predefined relationship with the fluid port's position.

2. The fluidic device of claim 1, wherein the planar coupling member protrudes laterally from the fluidic device.

3. The fluidic device of claim 1, further comprising at least one of:
the planar coupling member is an accessory member that protrudes laterally from the fluidic device;
the planar coupling member is realized as a planar multilayer structure;
the planar coupling member is realized as a stack of two or more bonded sheets;
the planar coupling member is realized as a stack of two or more bonded metal sheets;
the planar coupling member is realized as a stack of two or more bonded sheets, with one or more of the sheets being machined in a way that the fluid conduit is formed in the stack;
the planar coupling member is realized as a stack of two or more metal sheets, wherein an abrasive process, preferably electrochemical milling or chemical milling, is used for processing the metal sheets;
the planar coupling member is realized as a stack of two or more bonded sheets, the fluid port being realized as a via hole in an uppermost sheet, or in a lowermost sheet, or in both the uppermost and the lowermost sheet of the planar coupling member;
the planar coupling member is realized as a stack of two or more bonded metal sheets, the metal sheets being coated with plastic material or with a hot-melt adhesive before being bonded;
the planar coupling member is realized as a stack of two or more bonded metal sheets, the metal sheets being bonded by a joining process, preferably by diffusion welding;
the planar coupling member is realized as a stack of two or more bonded metal sheets, the metal sheets being electroplated before being bonded by diffusion welding;
the fluidic device is realized as a stack of two or more bonded sheets;
the fluidic device is realized as a stack of two or more bonded metal sheets;
the contour of the planar coupling member is an outer contour;
the contour of the planar coupling member is provided by the planar coupling member's boundary;
the contour of the planar coupling member is an inner contour of a cut-out of the planar coupling member;
the contour of the planar coupling member is one of: a circular contour, a polygonal contour;
the fluidic device is an interconnection strip comprising a first planar coupling member at the interconnection strip's first end and a second planar coupling member at the interconnection strip's second end;
the fluidic device is an interconnection strip comprising a first planar coupling member at the interconnection strip's first end and a second planar coupling member at the interconnection strip's second end, wherein the first planar coupling member comprises a first fluid port, wherein the second planar coupling member comprises a second fluid port, and wherein the interconnection strip comprises a fluid conduit adapted for fluidically connecting the first fluid port and the second fluid port;
the planar coupling member comprises a contact surface, the fluid port being located within the contact surface;
the planar coupling member comprises a contact surface, the fluid port being located within the contact surface, and the contact surface's area is several times as large as the fluid port's cross section;
the fluidic device comprises a plurality of fluid conduits, and the planar coupling member comprises a plurality of fluid ports, the fluid ports being fluidically coupled with corresponding fluid conduits;
the planar coupling member is adapted for being clamped together with another planar coupling member of another fluidic device, wherein a fluidic connection is established between the fluid port of the planar coupling member and a corresponding fluid port of said another planar coupling member; and
the fluidic device comprises one of: a switching valve, a reaction chamber, a pumping unit, a heat exchanger, a mixing device.

4. A fluidic system comprising
a first fluidic device according to claim 1, the first fluidic device comprising a first planar coupling member;
a clamping device comprising a fitting adapted to the contour of the first planar coupling member, the clamping device being adapted for clamping the first planar coupling member and for bringing the fluid port of the first planar coupling member to a predefined position.

5. The fluidic system of claim 4, further comprising a second fluidic device, the second fluidic device comprising a second planar coupling member.

6. The fluidic system of claim 5, further comprising at least one of
the clamping device is adapted for clamping together the first planar coupling member of the first fluidic device and the second planar coupling member of the second fluidic device, thereby establishing a fluidic connection between the fluid port of the first planar coupling member and a corresponding fluid port of the second planar coupling member;
the first planar coupling member comprises a plurality of fluid ports, the second planar coupling member comprises a plurality of fluid ports, and a plurality of fluidic connections are established between the fluid ports of the first planar coupling member and corresponding fluid ports of the second planar coupling member;
the first planar coupling member's contour matches with the second planar coupling member's contour;
the first planar coupling member comprises a plurality of fluid ports, the second planar coupling member comprises a plurality of fluid ports, each of the fluid ports' positions being in a predefined relationship with a contour of the respective planar coupling member;
the clamping device is adapted for aligning the first planar coupling member of the first fluidic device with the second planar coupling member of the second fluidic device, to provide for a fluidic connection between the fluid port of the first planar coupling member and a corresponding fluid port of the second planar coupling member;
the clamping device is adapted for pressing a contact surface of the first planar coupling member against a corresponding contact surface of the second planar coupling member, thereby establishing a fluidic connection between the fluid port of the first planar coupling member and a corresponding fluid port of the second planar coupling member;
the clamping device is adapted for pressing a contact surface of the first planar coupling member against a corresponding contact surface of the second planar coupling member, with a small plate, preferably a gold plate, being placed between the contact surface of the first planar coupling member and the corresponding contact surface of the second planar coupling member;
the first planar coupling member comprises a contact surface, the second planar coupling member comprises a contact surface, and the contact surfaces serve as sealing surfaces; and
the clamping device is adapted for providing a detachable connection between the first planar coupling member and the second planar coupling member.

7. The fluidic system of claim 5, further comprising at least one of:
a clamping force of the clamping device is sufficiently strong to provide for a fluid-tight fluidic connection between the fluid port of the first planar coupling member and the corresponding fluid port of the second planar coupling member;
a clamping force of the clamping device is sufficiently strong to provide for a fluid-tight fluidic connections between the fluid port of the first planar coupling member and the corresponding fluid port of the second planar coupling member at fluid pressures of up to 1200 bar;
for pressing the first planar coupling member against the second planar coupling member, the clamping device comprises one or more of: a screw, a headless screw, a grub screw, a wedge, a clamp lever, a bent lever, a bell-crank lever, a hydraulic cylinder; and
the clamping device comprises a grub screw adapted for pressing a contact surface of the first planar coupling member against a contact surface of the second planar coupling member when the grub screw is tightened.

8. The fluidic system of claim 5, further comprising at least one of:
the clamping device is adapted for clamping the first planar coupling member at different positions relative to the second planar coupling member, wherein in each of the different positions, different fluidic connections are set up between fluid ports of the first planar coupling member and fluid ports of the second planar coupling member;
the first fluidic device comprises two or more different channels having different cross-sections, each of the channels being fluidically connected to a corresponding fluid port of the first planar coupling member, wherein one of the two or more different channels may be selected by setting the first planar coupling member to one of a set of different positions relative to the second planar coupling member; and
the clamping device is adapted for clamping together three or more planar coupling members of three or more different fluidic devices, thereby establishing fluidic connections between the three or more planar coupling members.

9. The fluidic system of claim 5, further comprising at least one of:
at least one of the first planar coupling member and the second planar coupling member comprises interlocking features that enforce a well-defined alignment of the first planar coupling member relative to the second planar coupling member;
at least one of the first planar coupling member and the second planar coupling member comprises interlocking features, the interlocking features comprising one or more of: a protrusion, a nose, a catching recess, a cut-out; and
a protrusion or a nose of one of the planar coupling members is adapted for engaging with a corresponding catching recess or a cut-out of the respective other planar coupling member, to enforce a well-defined alignment of the first planar coupling member relative to the second planar coupling member.

10. The fluidic system of claim 4, further comprising at least one of:
the clamping device comprises a fitting for a tubing or for a capillary, the clamping device being adapted for clamping the first planar coupling member of the first fluidic device in a way that a fluidic connection between the fluid port of the first planar coupling member and an inlet of the tubing or the capillary is established;
the clamping device comprises a stator element of a switching valve, the stator element comprising a set of stator ports, the clamping device being adapted for pressing the first planar coupling member against the stator element, thereby establishing fluidic connections between fluid ports of the first planar coupling member and corresponding stator ports of the stator element;
the fluidic system further comprises a rotor element pivotably mounted on the stator element;
the clamping device comprises a fitting for a detection cell, the clamping device being adapted for clamping the first planar coupling member of the first fluidic device in a way that a fluidic connection between the fluid port of the first planar coupling member and an inlet of the detection cell is established;
at the first planar coupling member, the fluid conduit of the first fluidic device branches out into a plurality of ramified fluid conduits, each fluid conduit being adapted for supplying fluid to a detection cell;
the clamping device comprises a fitting for a separation column, the clamping device being adapted for clamping the first planar coupling member of the first fluidic device in a way that a fluidic connection between the fluid port of the first planar coupling member and an inlet of the separation column is established;
the first planar coupling member is adapted for supplying fluid to a separation column; and
the first planar coupling member comprises a plurality of fluid ports adapted for supplying fluid to an inlet of a separation column, the plurality of fluid ports being adapted to provide for a homogeneous supply of fluid to the separation column.

11. An interconnection strip for providing fluidic connections, the interconnection strip being realized as a stack of two or more bonded metal sheets, the interconnection strip comprising
a first planar coupling member at the interconnection strip's first end, the first planar coupling member comprising a first fluid porter,
a second planar coupling member at the interconnection strip's second end, the second planar coupling member comprising a second fluid port,
a fluid conduit adapted for fluidically connecting the first fluid port and the second fluid port.

12. A method for manufacturing a fluidic device for providing fluidic connections, the fluidic device comprising a planar coupling member, the method comprising
microstructuring one or more metal sheets;
stacking the microstructured metal sheets;
bonding the metal sheets by subjecting the metal sheets to a joining technique to form a multilayer structure.

13. The method of the claim 12, comprising at least one of:
the planar coupling member is an accessory member that protrudes laterally from the fluidic device;
microstructuring comprises applying an abrasive process, preferably electrochemical milling or chemical milling, to one or more of the metal sheets;
diffusion welding is used as a joining technique for bonding the metal sheets;
the metal sheets are electroplated before being subjected to diffusion welding; and
the metal sheets are coated with plastic material or with a hot-melt adhesive, pressed together and exposed to heat for a predefined period of time.

14. A method for fluidically connecting a first fluidic device and a second fluidic device, each of the first and the second fluidic device comprising a fluid conduit and a planar coupling member with a fluid port, the fluid port being fluidically connected with the fluid conduit, the method comprising
aligning the planar coupling member of the first fluidic device with the planar coupling member of the second fluidic device in a clamping device,
pressing the planar coupling member of the first fluidic device against the planar coupling member of the second fluidic device, whereby a fluidic connection is established between the fluid port of the first fluidic device and the corresponding fluid port of the second fluidic device.
